(19) United States
(12) Patent Application Publication
(10) Pub. No.: US 2006/0249484 A1
(43) Pub. Date: Nov. 9, 2006

(54) Method for connecting a hollow profile to a two-dimensionally contacting component

(76) Inventors: Rolf Pfeifer, Eislingen (DE); Jialin Shen, Bernstadt (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/559,164

(22) PCT Filed: Apr. 22, 2004
(86) PCT No.: PCT/EP04/04271

§ 371 Date: Jul. 14, 2006

(30) Foreign Application Priority Data
May 24, 2003 (DE) 103237194

(51) Int. Cl. B23K 1/00

(52) U.S. Cl. 219/85.15

(57) ABSTRACT

The invention relates to a process for joining a hollow profiled section (1) to a component (2) of a vehicle which bears flat against it by means of soldering, with a solder (4) being introduced between the hollow profiled section (1) and the component (2) and then being liquefied by the introduction of energy and, as it solidifies, producing a fixed join between the hollow profiled section (1) and the component (2). To achieve a durable soldered join between the hollow profiled section (1) and a component (2) of any desired configuration which bears flat against it in a simple way, it is proposed that a hollow (3) is formed on the component (2), in that the solder (4) is deposited in the hollow (3), in that the component (2) is then positioned relative to the hollow profiled section (1) with the hollow opening (6) facing the hollow profiled section (1), and in that then, in the contact position, the component (2) is acted on by resistive electricity in the hollow region, with a compressive force being exerted on the hollow outer side (8) by means of a resistance-welding electrode.

### CROSS REFERENCE TO RELATED APPLICATION

This application is a national stage of PCT/EP2004/004271 filed Apr. 22, 2004 and based upon DE 103 23 719.4 filed May 24, 2003 under the International Convention.

### BACKGROUND OF THE INVENTION

1. Field of the Invention

The invention relates to a process for joining a hydroformed hollow profiled section to a component which bears flat against it in.

2. Related Art of the Invention

A process of the generic type is known from DE 100 51 512 A1. In this process, a roof rack of a motor vehicle, which has been hydroformed from a hollow profiled section, is joined to a roof outer panel. For this purpose, a substantially planar bearing surface, against which a section of the surface of the roof outer panel bears, is formed out of the hollow profiled section. To join the two components to one another, a solder is introduced between the hollow profiled section and the component, and this solder is then liquefied by the introduction of energy and, as it solidifies, produces a fixed join between the hollow profiled section and the component.

During soldering, the solder is generally applied in the edge region of one of the components to be joined and then correspondingly heated by means of a flame, an arc, a torch, a furnace, a high-temperature salt bath, after which the two components are securely joined to one another only there. However, the requirement that the two components be in contact with one another in the edge region is not always satisfied for various configurations of the hollow profiled sections and components to be joined, and consequently the free application of solder to surfaces which bear against one another is not possible or is only possible with considerable difficulty, on account of the difficulty of gaining access to these surfaces. A variant on this is for a slab of solder to be arranged between the hollow profiled section and the component. A slab of solder of this type uses up large amounts of resources compared to the frequent requirement for joins which are only punctiform or linear. Furthermore, if the components are of complex three-dimensional design, it is not possible for a flat slab of solder to be put in place in any case.

### SUMMARY OF THE INVENTION

The invention is based on the object of developing a process of the generic type in such a way that a durable soldered join between a hollow profiled section and a component of any desired form which bears flat against it is achieved in a simple way.

On account of a pocket-shaped hollow being formed in the component to be joined and the solder being arranged in this hollow at the locations of the component at which it bears flat against the hollow profiled section, components which are formed from metal sheet and are of any desired, i.e. even very complex form—but with the exception of peripherally continuous hollow profiled sections—can be reliably joined by soldering to in particular hydroformed hollow profiled sections. The requirements that the dispensing of solder be accessible and that heat be supplied in this case no longer play a major role, since the solder on the one hand is already positioned selectively on the component to be joined, and this component merely has to be arranged in a suitable way on the hollow profiled section, and on the other hand heating is deliberately effected indirectly via the component by means of resistance-welding electrode. Therefore, the only requirement for the soldering according to the invention is that the wall of the component to be joined be accessible on just one side. In order therefore to introduce the solder between the hollow profiled section and the component, according to the invention firstly the hollow opening is positioned facing the hollow profiled section. Secondly, the solder, which is liquefied without great difficulty by electrical resistance heating, is pressed toward the hollow profiled section by the electrode pressing on the hollow outer side, and is therefore pressed toward the gap between hollow profiled section and component, after which the solder is drawn into the gap by capillary action. After the solder has solidified, the component is fixedly joined to the hollow profiled section not only within the hollow but also in the adjoining region outside the hollow, and thus ensures a completely durable join which can withstand mechanical stresses. In addition to being simple and quick to carry out, the process according to the invention also preserves the contours of the fully deformed hollow profiled section. On account of the specific temperature range used for the soldering and the briefness of heating, only very slight distortion which could adversely affect the final shape of the hollow profiled section occurs in the hollow profiled section. Also, the process force, i.e. the compressive force, is at a level which does not cause any undesirable indentations to the hollow profiled section as a result of plastic deformation, which is particularly necessary when using a hollow profiled section whereof the desired contour has been shaped very accurately by hydroforming.

### BRIEF DESCRIPTION OF THE DRAWINGS

Expedient configurations of the invention can be found in the subclaims; otherwise, the invention is explained in more detail below on the basis of two exemplary embodiments illustrated in the drawings, in which:

FIG. 1 shows a perspective longitudinal section through an excerpt of an assembly of a hollow profiled section and a component with a hollow stamped into it which is to be soldered in accordance with the invention,

FIG. 2 shows a perspective longitudinal section through an excerpt of an assembly of a hollow profiled section and a component with a tab cut out of it which is to be soldered in accordance with the invention.

### DETAILED DESCRIPTION OF THE INVENTION

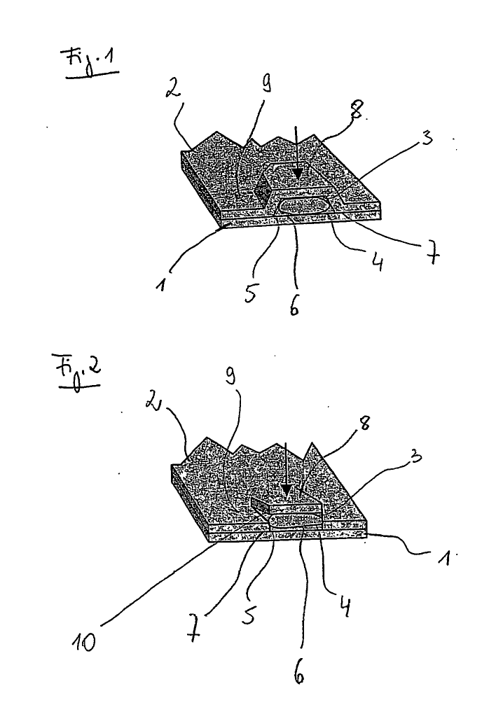

FIG. 1 illustrates a peripherally continuous hollow profiled section 1 which has been formed by hydroforming and can be used, for example, in the bodywork of motor vehicles. After it has been formed, the hollow profiled section 1 can be in the form of a box section or at least have a planar joining surface, which particularly increases the durability of the join which can be achieved, on account of the increased area available for one or more joining locations. A component 2 of the vehicle bears flat against the hollow profiled section 1 by means of a likewise planar section, it being possible for the component 2, by way of example, to be a body panel. The component 2 may also be rounded where it is in contact with the hollow profiled section 1 or designed with only a narrow planar section, for example a flange, which although reducing the joining area is still possible within the scope of the invention and in fact is the more common situation encountered in practice. The hollow profiled section 1 and the component 2, when used in the automotive industry, are formed from a steel sheet or from light metal. In this respect, the hollow profiled section 1 and component 2 may also be formed from different materials.

The component 2 now has a hollow 3, which is in this case trapezoidal in cross section, at the joining location. The hollow 3 may have been formed as early as during production of the component 2 in a single operation as part of the deep-drawing or pressing process. The hollow 3, the depth of which may be from one to three times the wall thickness of the component wall, may also be retrospectively stamped out of the component 2 which has been fully shaped—apart from the hollow 3—by means of a stamping ram, which simplifies the apparatus used for the preceding deep-drawing or pressing operation, on account of the formation of the component 2 and of the hollow 3 being separated. A solder 4 is jammed into the hollow 3; its initially free surface, in its position of use, ends flush with the hollow edge 5 or is set back from this edge into the hollow 3. In a manner which is economical in terms of process technology, and with a reduction in the outlay on apparatus, the production of the hollow 3 and the deposition of the solder 4 in the hollow 3 can be carried out by means of a common ram in one working step or in a plurality of successive process steps, in which case the abovementioned stamping ram has to be designed in suitable form, for example as a double ram, in which an inner ram is guided telescopically within the outer ram.

To join the component 2 to the hollow profiled section 1, the component 2 is positioned relative to the hollow profiled section 1 with the hollow opening 6 facing the hollow profiled section 1, resulting in planar bearing contact between the hollow profiled section 1 and the component 2 at the desired position. This bearing contact does not necessarily require the joining partners to be planar. However, it is important that the joining partners bear flat against one another and have the same contours over the section to be joined. Then, in this position, an electric voltage is applied to the component 2 in the region of the hollow and to the hollow profiled section 1, with the component 2 and hollow profiled section 1 being connected to different electrical poles. In the process, at the location of the hollow 3, the component 2 is acted on by a force from the resistance-welding electrode. The solder 4 is liquefied by the flowing current, i.e. by the introduction of electrical energy, and displaced toward the gap 7 between component 2 and hollow profiled section 1 by the compressive force which is applied by the resistance-welding electrode to the hollow outer side 8 as indicated in the direction of the arrow (cf. also FIG. 2). Here, the solder 4 is drawn between the two joining partners in a thin layer by the capillary action of the join 7 and forms alloys with each of the two joining partners. After the solder 4 has solidified, a fixed join has been formed between the hollow profiled section 1 and the component 2. During this operation, the hollow 3 is substantially leveled. In this exemplary embodiment, it is advantageous for the leveling for the component 2 to be thin-walled at least at the location of the hollow 3, so that there it can more easily be deformed by the compressive force of the electrode.

A further improvement to the application of pressure to the solder 4 is achieved by two opposite peripheral regions of the hollow 3 being completely severed, in such a manner that these peripheral regions are spaced apart in the peripheral direction of the hollow 3 by in each case a peripheral region which is attached to the component 2. This measure makes the wall of the hollow more flexible, so that the pressures which the electrode has to apply to displace the solder 4 are considerably lower. In this case, however, a small proportion of the solder 4 may penetrate outward through the slots formed during the severing.

This can be counteracted if the formation of the hollow and the severing of the peripheral regions is carried out by means of two rams which act against one another, in the manner of double-bend joining, and the hollow wall is compressed in such a manner that the edge of the wall of the hollow 3 is widened and, undercutting the severed edge, bears against the rear side 9 of the component 2, remote from the hollow profiled section 1, outside the hollow 3. The flexibility of the hollow wall is substantially retained in the process.

In a variant on the above exemplary embodiment, as shown in FIG. 2, to form the hollow, a tab 10 is cut out of the component 2 and pressed a small amount out of the component wall, with the tab 10 remaining attached to the component 2 at one end. The space which forms between the protruding position of the tab 10 and the position of the tab 10 before it is pushed out forms the hollow 3. Forming the tab 10, which is contact-connected by the electrode for the soldering operation, means that, on account of the particularly high elasticity and mobility of the tab 10, only a very low pressure has to be applied to the solder 4 to displace it. As also in the above exemplary embodiment relating to the production of the hollow 3 in the style of double-bend joining, the reduced pressure which has to be exerted on the solder 4 by the electrode means that the surface contour of the hollow profiled section 1 remains virtually unaffected.

1. A process for joining a hollow profiled section to a component of a vehicle which bears flat against it by means of soldering, with a solder being introduced between the hollow profiled section and the component and then being liquefied by the introduction of energy and, as it solidifies, producing a fixed join between the hollow profiled section and the component, comprising
forming a hollow (3) on the component (2), depositing the solder (4) in the hollow (3),
positioning the component (2) relative to the hollow profiled section (1) with the hollow opening (6) facing the hollow profiled section (1), and
then, in the contact position, acting on the component (2) by resistive electricity in the hollow region, with a compressive force being exerted on the hollow outer side (8) by means of a resistance-welding electrode.

2. The process as claimed in claim 1, wherein the hollow (3) is stamped out of the component (2).

3. The process as claimed in claim 1, wherein two opposite peripheral regions of the hollow (3) are completely severed, in such a manner that these peripheral regions are spaced apart in the peripheral direction by in each case a peripheral region which is attached to the component (2).

4. The process as claimed in claim 1, wherein to form the hollow, a tab (10) is cut and pressed out of the component (2), with the tab (10) remaining attached to the component (2) at one end.

5. The process as claimed in claim 1, wherein the production of the hollow (3) and the deposition of the solder (4) in the hollow (3) are carried out by means of a common ram in a single working step or in a plurality of successive process steps.
